(19) United States
(12) Patent Application Publication
(10) Pub. No.: US 2020/0386405 A1
(43) Pub. Date: Dec. 10, 2020

(54) AIRCRAFT ENGINE AND METHOD OF OPERATING SAME

(71) Applicant: PRATT & WHITNEY CANADA CORP., Longueuil (CA)

(72) Inventors: David MENHEERE, Norval (CA); Santo CHIAPPETTA, Georgetown (CA); Timothy REDFORD, Campbellville (CA); Daniel VAN DEN ENDE, Mississauga (CA)

(21) Appl. No.: 16/433,664

(22) Filed: Jun. 6, 2019

(51) Int. Cl. F23R 3/42; F02C 3/04; F02C 7/36

(52) U.S. Cl. CPC F23R 3/42; F02C 3/04; F05D 2220/36; F05D 2220/323; F02C 7/36

(57) ABSTRACT

The aircraft engine can have a core gas path having a first combustor, a second gas path parallel to the core gas path, the second gas path having a second combustor, a turbine driven by the second gas path, a gearbox driven by the turbine, and a valve configured for selectively opening and closing the second gas path.

### TECHNICAL FIELD

The application related generally to aircraft engines, and more particularly to gas path configurations thereof.

### BACKGROUND OF THE ART

Aircraft turbine engines operate at a variety of design points, including takeoff and cruise, and are also designed in a manner to handle off-design conditions. Some aircraft can have large power differences between operating points, such as between takeoff and cruise for instance, which can pose a challenge when attempting to design an engine which is fuel efficient. Indeed, some aircraft engines are over-designed when viewed from the cruise standpoint, to be capable of handling takeoff power, which can result in operating the engine during cruise in a less than optimal regime from the standpoint of efficiency. Accordingly, there remained room for improvement.

### SUMMARY

In one aspect, there is provided an aircraft engine having a core gas path having a first combustor, a second gas path parallel to the core gas path, the second gas path having a second combustor, a turbine driven by the second gas path, a gearbox driven by the turbine, and a valve configured for selectively opening and closing the second gas path.

In another aspect, there is provided a method of operating an aircraft engine having a core gas path having a first combustor, a second gas path parallel to the core gas path, the second gas path having a second combustor, a turbine driven by both the core gas path and the second gas path, the method comprising: driving the turbine at a takeoff power level including simultaneously operating the first combustor and the second combustor in relation with the core gas path and the second gas path; subsequently to said driving the turbine at a takeoff power level for a given duration, closing the second gas path, shutting down the second combustor, and driving the turbine at a cruise power level solely via the core gas path.

In a further aspect, there is provided a turboprop or turboshaft engine comprising a core gas path having a first combustor, a second gas path parallel to the core gas path, the second gas path having a second combustor, a turbine driven by both the core gas path and the second gas path, and a valve configured for selectively opening and closing the second gas path.

### DESCRIPTION OF THE DRAWINGS

Reference is now made to the accompanying figures in which:

FIG. 1 is a schematic cross-sectional view of a turboshaft engine;

FIGS. 2A and 2B are schematic cross-sectional views of an aircraft engine in accordance with an embodiment, with FIG. 2A showing the second gas path closed and FIG. 2B showing the second gas path operational;

FIG. 3 is a schematic cross-sectional view of a turboprop engine.

### DETAILED DESCRIPTION

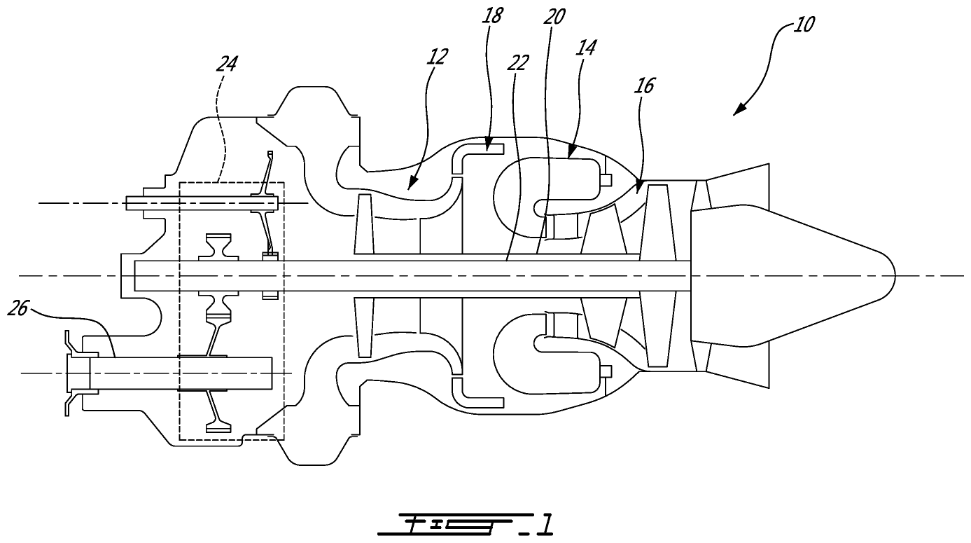

FIG. 1 illustrates an example of a turbine engine. In this example, the turbine engine 10 is a turboshaft engine generally comprising in serial flow communication, a multistage compressor 12 for pressurizing the air, a combustor 14 in which the compressed air is mixed with fuel and ignited for generating an annular stream of hot combustion gases, and a turbine section 16 for extracting energy from the combustion gases. The turbine engine terminates in an exhaust section.

The fluid path extending sequentially across the compressor 12, the combustor 14 and the turbine 16 can be referred to as the core gas path 18. In practice, the combustor 14 can include a plurality of identical, circumferentially interspaced, combustor units. In the embodiment shown in FIG. 1, the turboshaft engine 10 has two compressor and turbine stages, including a high pressure stage associated to a high pressure shaft 20, and a low pressure stage associated to a low pressure shaft 22. The low pressure shaft 22 is used as a power source during use.

Turboshaft engines, similarly to turboprop engines, typically have some form of gearing by which the power of the low pressure shaft 22 is transferred to an external shaft 26 bearing the blades or propeller. This gearing, which can be referred to as a gearbox 24 for the sake of simplicity, typically reduces the rotation speed to reach an external rotation speed which is better adapted to rotate the blades or propeller for instance.

Some applications, such as helicopters to name one example, can have large power differences between Take-Off (TO) and cruise. A typical helicopter can require less than 50% power to cruise versus its highest power rating, and this can result in the engine running in off-design condition for the majority of its mission, leaving a want for better fuel efficiency.

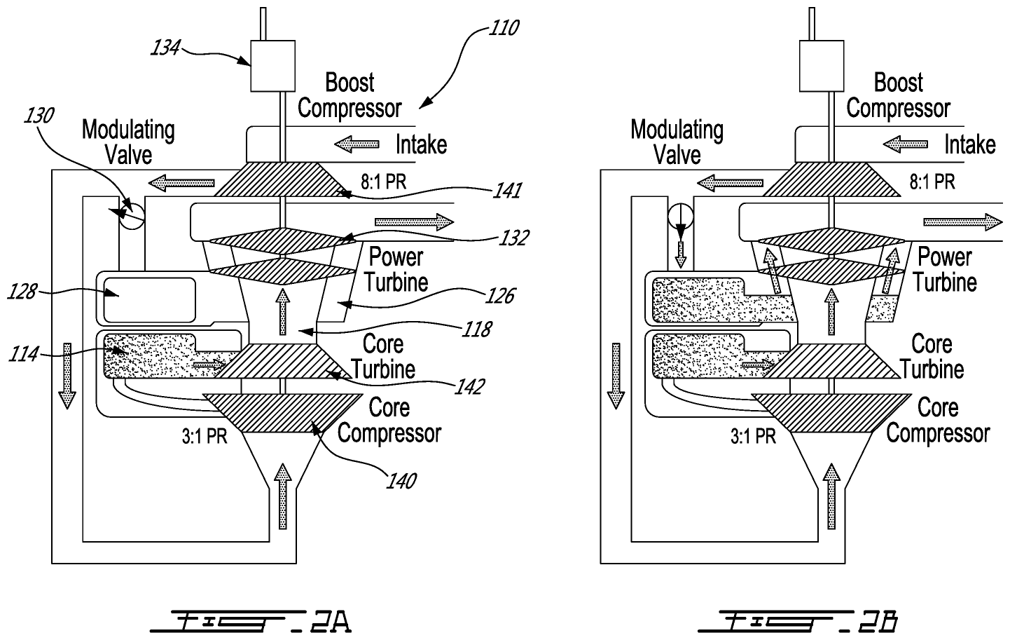

FIGS. 2A and 2B show an example of an aircraft engine 110 which has, in addition to a core gas path 118, a second gas path 126, parallel to the core gas path 118. The second gas path 126 also has a combustor, which will be referred to as the second combustor 128 herein for simplicity. The second combustor can include a plurality of circumferentially interspaced combustor units which are fed in parallel in usual combustion. A turbine 132, which can be a power turbine or a low pressure turbine for instance, is driven by the second gas path 126. A gearbox 134 can be driven by the turbine 132, such as in a turboshaft or turboprop configuration for instance. The second gas path 126 can be selectively openable and closeable, and/or controllable, by a device or system which will be referred to herein simply as a “valve” for the sake of simplicity. In this specific embodiment, the valve 130 is a modulating valve. Any suitable form of valve 130 can be used in alternate embodiments.

At takeoff, for instance, the second gas path 126 can be open, and the second combustor 128 can be activated, in a configuration shown in FIG. 2B. In this configuration, both the core gas path 118 and the second gas path 126 can generate power through a turbine, to reach a first power level. The first power level can correspond to a takeoff power requirement, for instance, or OEI power requirement, to name another example.

During cruise, the flow through the second gas path 126 can be reduced or stopped by the valve 130, while the core gas path 118 can continue to operate at a comparable rate, reducing the power available at the turbine 132 to a second power level, which can correspond to a cruise power requirement for instance.

It will be noted that the selective operation, or closing, of the second gas path 126 can be performed without substantial impact on the operation of the core gas path 118. Accordingly, during a typical flight, the same engine can be operated in two or more operating modes which can produce a significantly different power level while always operating at a relatively high level of efficiency, and without requiring an additional engine altogether. It will also be noted that the two different power levels can be achieved without a significant change of rotation speed of the turbine shaft, for instance.

For instance, at takeoff, the turbine 132 can be driven while simultaneously operating the first combustor 114 and the second combustor 128 in relation with the core gas path 118 and the second gas path 126. Then, after operating the turbine 132 at the takeoff power level for a given duration, the second gas path 126 can be closed and the second combustor 128 can be shut down, while the turbine 132 can continue to be driven solely via the core gas path 118, at a cruise power level.

In the context of a helicopter, for instance, it can be desired for the rotation speed of the turbine's shaft not to vary too much between the different power levels. The rotation speed of the turbine at the takeoff power level can be less than 140% of the rotation speed of the turbine at the cruise power level, for instance, possibly less than 130% (e.g. for turboprop), possibly less than 110% (e.g. for turboshaft), and even possibly less than 105%. This while the amount of power generated at the cruise power level can be less than ¾ of the amount of power generated at the takeoff power level, possibly less than ⅔^{rd}, and even possibly less than ½. In some embodiments, the second combustor will be at least 10% smaller than the first combustor. In some embodiments, the second combustor will be at least 20% smaller than the first combustor.

In an example where the OEI power level is higher than the takeoff power level, an aircraft engine can be designed in a manner for the OEI power level to be reachable by operating the core gas path and the second gas path at full power simultaneously, for instance.

If an engine with a single gas path was designed to reach such an OEI, the engine can rely on overall pressure ratio and temperature to generate the power required for its OEI condition, but then have components running off-design at cruise power, reducing engine efficiency. Moreover, in some cases, it is not possible to design the engine both for cruise condition, and in a manner to meet the power requirements for take-off or OEI, due to performance limitations of the components (temperature margins, compressor operating lines etc).

Designing a specific engine to meet both of these requirements—high power and cruise—with satisfactory efficiency at both conditions, but with only a single gas path, may not be feasible. It could be easier, based on the power requirements, to use two smaller engines at TO power and revert to a single powered engine in cruise. However, such a second engine may add weight, complexity, can reduce the reliability of the overall package, and can introduce subsequent challenges such as cold engine start times and OEI if one engine is turned off in flight (cruise).

FIGS. 2A and 2B show an example of an aircraft engine which has both a primary combustor 114 and a secondary combustor 128. In this example, the secondary combustor 128 takes air flow from a boost (low pressure) compressor 140, adds fuel and combusts the mixture injecting said mixture into the interturbine duct and through the power turbine 132. The additional flow through the power turbine 132 can increase the output power of the engine without significantly affecting the operating characteristics of the core. The core compressor 140 and turbine 142 can be optimized for a certain flight condition requirements yet the overall engine be able to meet the max power requirements for the entire envelope.

A boost compressor can be used to increase the power output of the engine. However, if the additional flow and pressure entering is pushed through the core, it influences the operating characteristics and limits the optimization of core components ultimately effecting the off boost performance in terms of power and specific fuel consumption (SFC).

The design shown in FIGS. 2A and 2B can enable the power of the engine to be increased by incorporating an auxiliary combustor into the engine architecture that also optimizes the off boost engine cycle in terms of SFC.

The use of the second combustor 128 can increase power (for takeoff), without significantly increasing the shaft speed of the common power turbine 132.

The example presented in FIGS. 2A and 2B show a vertical configuration where the boost compressor 141 is driven off the power turbine 132 but deposed from the core of the engine. In this configuration, the core is very simple and compact with no thru shaft. The core compressor 140 and the core turbine 142 are mounted on a high pressure shaft, with the first combustion chamber 114 therebetween. The second gas path 126 is positioned between a boost compressor 141 and a turbine 132, the latter two being on a second, low pressure shaft. The low pressure shaft and the high pressure shaft are axially offset from one another, can have coinciding axes, but are not concentric (around one another). In this embodiment, the flow from the boost compressor bifurcates to the second gas path 126 and to the core gas path 118. Here, the flow from both gas paths 118, 126 is conveyed through a same power turbine 132 downstream of the combustion chambers 114, 128. In this embodiment, the valve is a modulator valve. The engine can operate in unboosted mode by closing the modulator valve. When the modulator valve is closed the boost compressor can run in a lower pressure condition than when operating in boosted mode, minimizing any parasitic power losses. The intake can feed the core directly. FIG. 2A shows unboosted mode. Alternately, the modulator valve can be partially closed or open to allow minutely adjusting the flow through the second gas path.

In FIG. 2B, the same engine is shown configured for high power (boosted mode). Opening the modulator valve 130 can allow the boost to consume the intake flow and feed pressurized air to the secondary combustor. The flow from the secondary combustor can exhaust into the interturbine duct and pass through the power turbine.

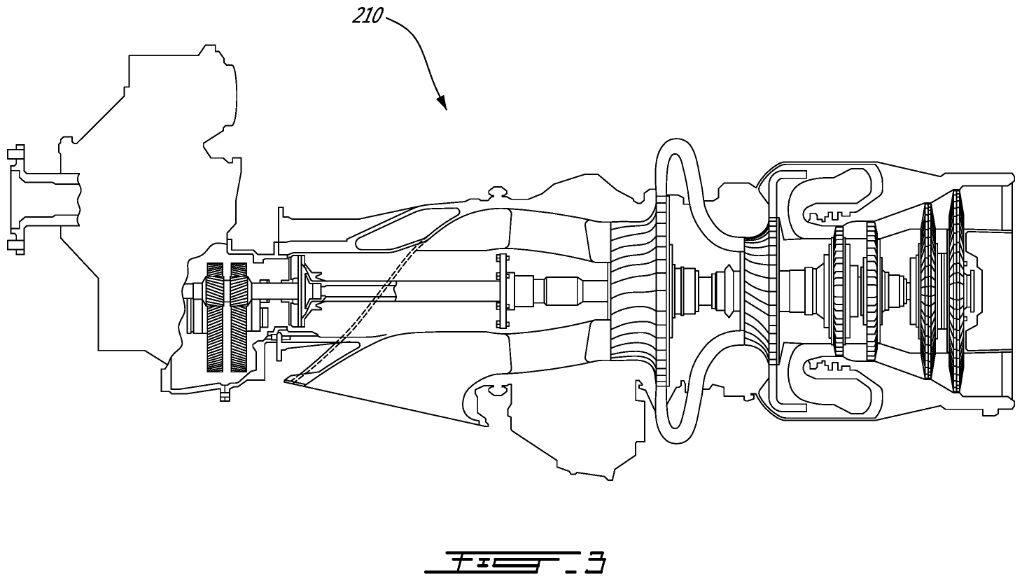

The above description is meant to be exemplary only, and one skilled in the art will recognize that changes may be made to the embodiments described without departing from the scope of the invention disclosed. Indeed, various modifications and adaptations are possible in alternate embodiments. FIG. 3, for instance, illustrates a turboprop 210 adapted to drive a propeller, and which may be modified based on the teachings presented above in a manner to incorporate a selectively useable second gas path powered by a second combustor. It will be understood that various engine architectures are possible in alternate embodiments. In such alternate embodiments, the turbine driven by the second gas path may not be driven by the core gas path at all, and the core gas path can be used to drive something else. The gearbox may not be driven by a turbine but by another mechanism. The turbine which is driven by the second gas path may not drive a boost compressor, or it may do so but this boost compressor may not be upstream of both the core gas path and the second gas path.

Still other modifications which fall within the scope of the present invention will be apparent to those skilled in the art, in light of a review of this disclosure, and such modifications are intended to fall within the appended claims.

1. An aircraft engine having a core gas path having a first combustor, a second gas path parallel to the core gas path, the second gas path having a second combustor, a turbine disposed to be driven in use by air flowing through the second gas path, a gearbox driven by the turbine, and a valve configured for selectively opening and closing the second gas path.

2. The aircraft engine of claim 1 wherein the core gas path further has a core compressor upstream of the first combustor, and a core turbine downstream of the first combustor.

3. The aircraft engine of claim 1 wherein the turbine is also driven by the core gas path.

4. The aircraft engine of claim 1 wherein the aircraft engine is a turboshaft engine, further comprising helicopter blades mounted to a power shaft, the power shaft driven by the gearbox.

5. The aircraft engine of claim 1 wherein the aircraft engine is a turboprop engine, further comprising a propeller mounted to a power shaft, the power shaft being driven by the gearbox.

6. The aircraft engine of claim 3 wherein the core gas path is configured for driving the turbine at a power level corresponding to a cruise power requirement of the aircraft engine.

7. The aircraft engine of claim 6 wherein the second gas path is configured for adding power to the turbine for reaching a takeoff power requirement of the aircraft engine.

8. The aircraft engine of claim 1 further comprising a boost compressor driven by the turbine, the boost compressor upstream of both the core gas path and the second gas path.

9. A method of operating an aircraft engine having a core gas path having a first combustor, a second gas path parallel to the core gas path, the second gas path having a second combustor, a turbine driven by both the core gas path and the second gas path, the method comprising:
driving the turbine at a takeoff power level including simultaneously operating the first combustor and the second combustor in relation with the core gas path and the second gas path;
subsequently to said driving the turbine at a takeoff power level for a given duration, closing the second gas path, shutting down the second combustor, and driving the turbine at a cruise power level solely via the core gas path.

10. The method of claim 9 wherein a rotation speed of the turbine at the takeoff power level is less than 120% of a rotation speed of the turbine at the cruise power level.

11. The method of claim 9 wherein a rotation speed of the turbine at the takeoff power level is less than 110% of a rotation speed of the turbine at the cruise power level.

12. The method of claim 9 wherein a rotation speed of the turbine at the takeoff power level is less than 105% of a rotation speed of the turbine at the cruise power level.

13. The method of claim 9 wherein the cruise power level is of less than ¾ of the takeoff power level.

14. The method of claim 9 wherein the cruise power level is of less than ⅔ of the takeoff power level.

15. The method of claim 9 wherein the cruise power level is of less than ½ of the takeoff power level.

16. A turboprop or turboshaft engine comprising a core gas path having a first combustor, a second gas path parallel to the core gas path, the second gas path having a second combustor, a turbine driven by both the core gas path and the second gas path, and a valve configured for selectively opening and closing the second gas path.

17. The turboprop or turboshaft engine of claim 16 further comprising a gearbox driven by the turbine.

18. The turboprop or turboshaft engine of claim 16 wherein the core gas path further has a core compressor upstream of the first combustor, a core turbine downstream of the first combustor, and a boost compressor driven by the turbine, the boost compressor upstream of both the core gas path and the second gas path.

19. The aircraft engine of claim 16 wherein the core gas path is configured for driving the turbine at a power level corresponding to a cruise power requirement of the aircraft engine.

20. The aircraft engine of claim 1 wherein the second combustor is at least 10% smaller than the first combustor.
